(19) United States
(12) Patent Application Publication
(10) Pub. No.: US 2009/0047824 A1
(43) Pub. Date: Feb. 19, 2009

(54) Connector Alignment System

(75) Inventors: Philip Seibert, Round Rock, TX (US); Ernesto Ramirez, Austin, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 11/839,013

(22) Filed: Aug. 15, 2007

(51) Int. Cl. H01R 3/00

(52) U.S. Cl. 439/490

(57) ABSTRACT

A connector alignment apparatus includes a first connector. A first proximity sensor element is operable to sense when a second connector is positioned proximate to the first connector. An indicator is coupled to the first proximity sensor element and operable to provide an indication in response to the second connector being positioned proximate to the first connector. The indicator may provide a visual indication of the direction to move the second connector in such that the second connector is proximate to and aligned with the first connector. Once proximate and aligned, the second connector may be mated with the first connector.

### BACKGROUND

The present disclosure relates generally to information handling systems, and more particularly to a connector alignment system for an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

IHSs typically include a number of connectors that may be coupled to other connectors in order to provide functionality for the IHS. For example, a male connector on a docking station or media slice may mate with a female connector on an IHS in order to connect the IHS to the docking station or media slice. In mating the male connector with the female connector, it may be desirable to assure that the male connector and female connector are properly aligned with one another in order to prevent damage from occurring to either of the connectors. Such alignment of male connectors and female connectors raises a number of issues.

Typically, a plurality of mechanical alignment features will be provided adjacent the male connector and the female connector in order to align the connectors for mating. For example, mechanical alignment features on a docking station may be designed to prevent a male connector on the docking station from engaging a female connector on the IHS unless those mechanical alignment features properly engage mechanical alignment features on the IHS. Only after proper engagement of the mechanical alignment features on the docking station and the IHS is the male connector allowed to engage and mate with the female connector. This reduces the chances of the male connector and female connector being damaged due to an attempt to mate them when they are misaligned.

However, such conventional mechanical alignment features constrain the mechanical design of the IHS throughout the life of the docking station. For example, once the mechanical alignment features have been defined on the docking station, all IHSs designed for that docking station must have mechanical alignment features located on the IHS as dictated by the mechanical alignment features on the docking station. The IHS architecture (e.g. the size and/or placement of the batteries) may then be constrained by the need to provide such features in order to allow the IHS to properly connect to the docking station.

Accordingly, it would be desirable to provide an improved connector alignment system.

### SUMMARY

According to one embodiment, a connector alignment apparatus includes a first connector, a first proximity sensor element that is operable to sense when a second connector is positioned proximate to the first connector; and an indicator coupled to the first proximity sensor element and operable to provide an indication in response to the second connector being positioned proximate to the first connector.

### BRIEF DESCRIPTION OF THE DRAWINGS

FIG. 1 is a schematic view illustrating an embodiment of an IHS.

FIG. 2a is a top view illustrating an embodiment of a docking device.

FIG. 2b is a side view illustrating an embodiment of the docking device of FIG. 2a.

FIG. 3 perspective view illustrating an embodiment of an IHS used with the docking device of FIGS. 2a and 2b.

FIG. 4a is a flow chart illustrating an embodiment of a method for aligning connectors.

FIG. 4b is a top view illustrating an embodiment of the IHS of FIG. 3 being aligned with the docking device of FIGS. 2a and 2b.

FIG. 4c is a top view illustrating an embodiment of a connector on the IHS of FIG. 3 aligned with a connector on the docking device of FIGS. 2a and 2b.

FIG. 4d is a side view illustrating an embodiment of a connector on the IHS of FIG. 3 aligned with a connector on the docking device of FIGS. 2a and 2b.

FIG. 4e is a side view illustrating an embodiment of a connector on the IHS of FIG. 3 mated with a connector on the docking device of FIGS. 2a and 2b.

FIG. 5 is a top view illustrating an embodiment of a docking device.

FIG. 6 perspective view illustrating an embodiment of an IHS used with the docking device of FIG. 5.

FIG. 7a is a flow chart illustrating an embodiment of a method for aligning connectors.

FIG. 7b is a top view illustrating an embodiment of the IHS of FIG. 6 being aligned with the docking device of FIG. 5.

FIG. 7c is a top view illustrating an embodiment of a connector on the IHS of FIG. 6 aligned with a connector on the docking device of FIG. 5.

FIG. 8a is a front perspective view illustrating an embodiment of an IHS.

FIG. 8b is a rear perspective view illustrating an embodiment of the IHS of FIG. 8a.

FIG. 8c is a front view illustrating an embodiment of a connector on the IHS of FIGS. 8a and 8b.

FIG. 8d is a front view illustrating an embodiment of a connector on the IHS of FIGS. 8a and 8b.

FIG. 9 is a top view illustrating an embodiment of a connector used with the IHS of FIGS. 8a, 8b, 8c and 8d.

FIG. 10 is a top view illustrating an embodiment of a connector used with the IHS of FIGS. 8a, 8b, 8c and 8d.

FIG. 11a is a flow chart illustrating an embodiment of a method for aligning connectors.

FIG. 11b is a front view illustrating an embodiment of the connector of FIG. 10 being positioned in a misaligned orientation adjacent the connector on the IHS of FIG. 8d.

FIG. 11c is a perspective view illustrating an embodiment of the IHS of FIG. 8a with the connector of FIG. 10 mated with the connector on the IHS of FIG. 8d.

### DETAILED DESCRIPTION

For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (CPU) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

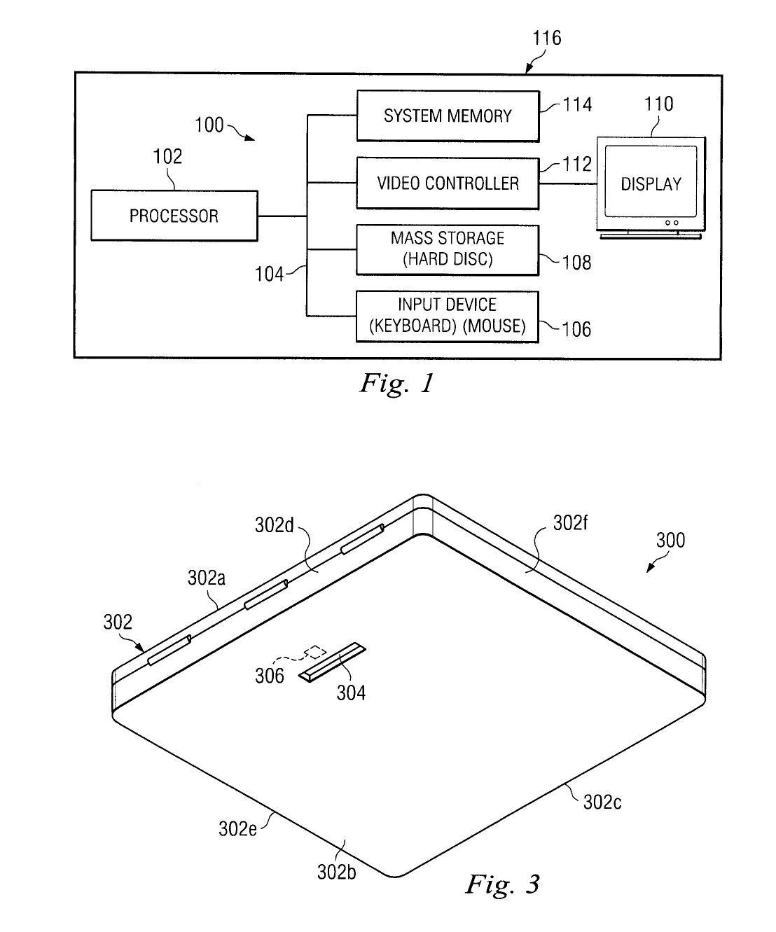

In one embodiment, IHS 100, FIG. 1, includes a processor 102, which is connected to a bus 104. Bus 104 serves as a connection between processor 102 and other components of computer system 100. An input device 106 is coupled to processor 102 to provide input to processor 102. Examples of input devices include keyboards, touchscreens, and pointing devices such as mouses, trackballs and trackpads. Programs and data are stored on a mass storage device 108, which is coupled to processor 102. Mass storage devices include such devices as hard disks, optical disks, magneto-optical drives, floppy drives and the like. IHS 100 further includes a display 110, which is coupled to processor 102 by a video controller 112. A system memory 114 is coupled to processor 102 to provide the processor with fast storage to facilitate execution of computer programs by processor 102. In an embodiment, a chassis 116 houses some or all of the components of IHS 100. It should be understood that other buses and intermediate circuits can be deployed between the components described above and processor 102 to facilitate interconnection between the components and the processor 102.

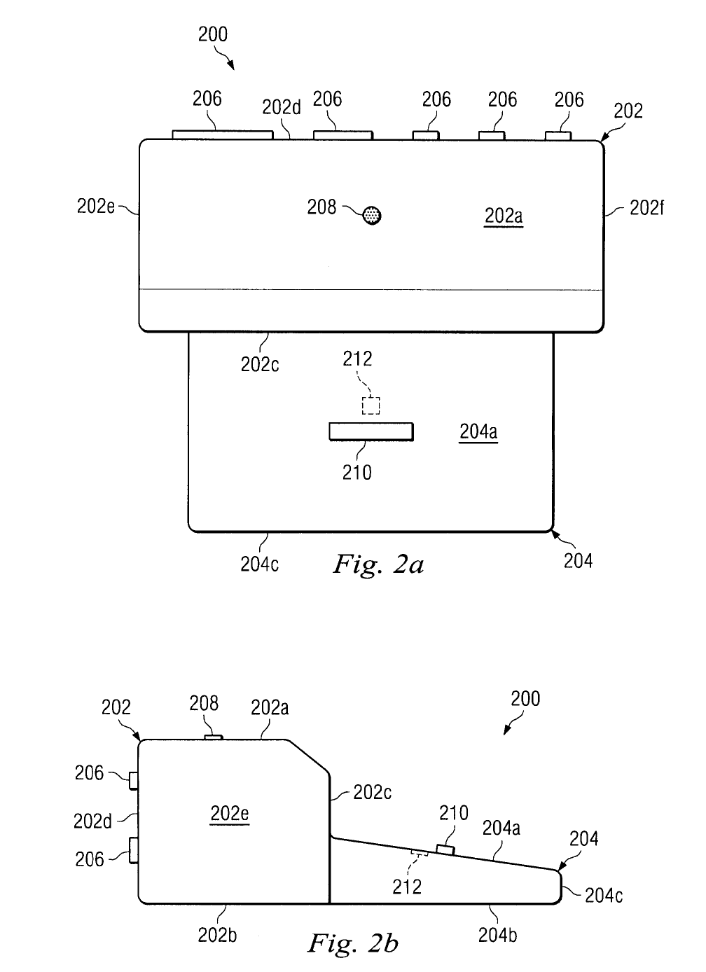

Referring now to FIGS. 2a and 2b, a docking device 200 is illustrated. The docking device 200 may be, for example, a docking station for a portable IHS, a media slice, a battery slice, and/or a variety of other docking devices known in the art. The docking device 200 includes a base 202 having a top surface 202a, a bottom surface 202b located opposite the top surface 202a, a front surface 202c extending between the top surface 202a and the bottom surface 202b, a rear surface 202d located opposite the front surface 202c and extending between the top surface 202a and the bottom surface 202b, a side surface 202e extending between the top surface 202a, the bottom surface 202b, the front surface 202c, and the rear surface 202d, and a side surface 202f located opposite the side surface 202e and extending between the top surface 202a, the bottom surface 202b, the front surface 202c, and the rear surface 202d. A system support 204 extends from the front surface 202c of the base 202 and includes a top surface 204a, a bottom surface 204b located opposite the top surface 204a and extending from the bottom surface 202b of the base 202, and a front surface 204c extending between the top surface 204a and the bottom surface 204b. A plurality of peripheral connectors 206 are located on the rear surface 202d of the base 202. An indicator 208 is located on the top surface 202a of the base 202. In an embodiment, the indicator 208 is operable to emit light and may be, for example, a light bulb, a light emitting device/diode (LED), and/or a variety of other devices operable to emit light known in the art. In an embodiment, the indicator 208 is an audio speaker. In an embodiment, the indicator 208 is both operable to emit light and sound. While the indicator 208 has been illustrated as located on the base 202 of the docking device 200, the indicator 208 may be located in a variety of other locations such as, for example, on a display (e.g. the display 110, described above with reference to FIG. 1) that is coupled to the docking device. A first connector 210 extends from and is centrally located on the top surface 204a of the system support 204. A first proximity sensor element 212 is located in the system support 204 and electrically coupled to the indicator 208. In an embodiment the first proximity sensor element 212 includes a Hall-effect sensor or Hall Integrated circuit (IC). In an embodiment, the first proximity sensor element 212 includes an optical sensor. In an embodiment, the first proximity sensor element 212 may be, for example, mechanical switches, reed switches, and/or a variety of other proximity sensing devices known in the art. As illustrated, the first proximity sensor element 212 is housed within the system support 204 and located adjacent the top surface 204a of the system support 204. However, the first proximity sensor element 212 may be located on the top surface 204a of the system support 204, on the front surface 202c of the base 202, and/or in a variety of other locations on the docking device 200 as will be explained further below in reference to a second proximity sensor element that the first proximity sensor element 212 is located to sense. In an embodiment, the docking device 200 is coupled to a plurality of IHS components (not shown) that provide functionality for the IHS such as, for example, displays, disk drives, printers, scanners, keyboards, and a plurality of other IHS components known in the art.

Referring now to FIG. 3, an IHS 300 is illustrated. The IHS 300 may be, for example, the IHS 100, described above with reference to FIG. 1. The IHS 300 includes a includes a base 302 having a top surface 302a, a bottom surface 302b located opposite the top surface 302a, a front surface 302c extending between the top surface 302a and the bottom surface 302b, a rear surface 302d located opposite the front surface 302c and extending between the top surface 302a and the bottom surface 302b, a side surface 302e extending between the top surface 302a, the bottom surface 302b, the front surface 302c, and the rear surface 302d, and a side surface 302f located opposite the side surface 302e and extending between the top surface 302a, the bottom surface 302b, the front surface 302c, and the rear surface 302d. A second connector 304 is located on the bottom surface 302b of the base 302. A second proximity sensor element 306 is located in the base 302. In an embodiment the second proximity sensor element 306 includes a magnet that is detectable by a Hall-effect sensor or Hall IC. In an embodiment, the second proximity sensor element 306 includes an element that is detectable by an optical sensor. In an embodiment, the second proximity sensor element 306 may be, for example, elements operable to be detected by mechanical proximity switches, reed switches, and/or a variety of other proximity sensing devices known in the art. As illustrated, the second proximity sensor element 306 is housed within base 302 and located adjacent the bottom surface 302b of the base 302. However, the second proximity sensor element 306 may be located on the bottom surface 302b of the base 302, on the rear surface 302d of the base 302, and/or in a variety of other locations on the IHS 300 as will be explained further below in reference to the first proximity sensor element 212 that is located on the docking device 200 to sense the second proximity sensor element 306.

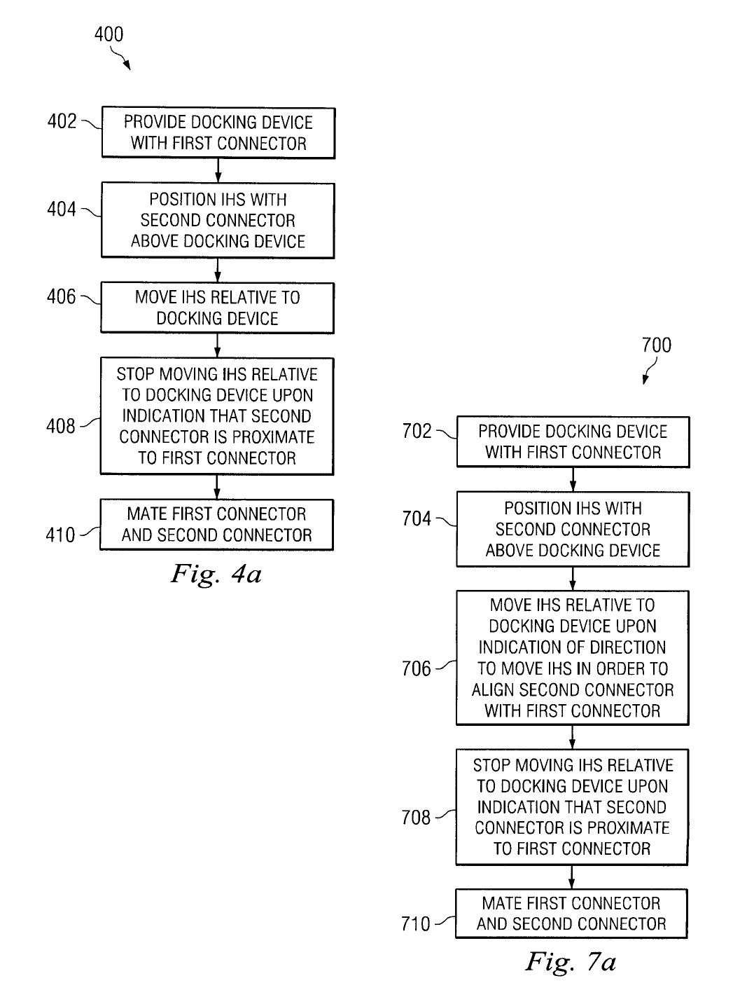

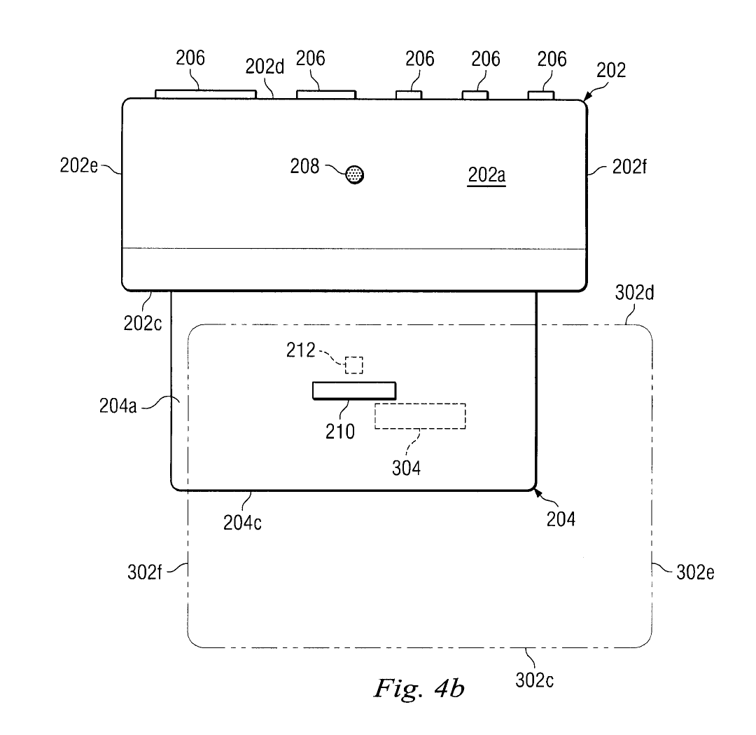

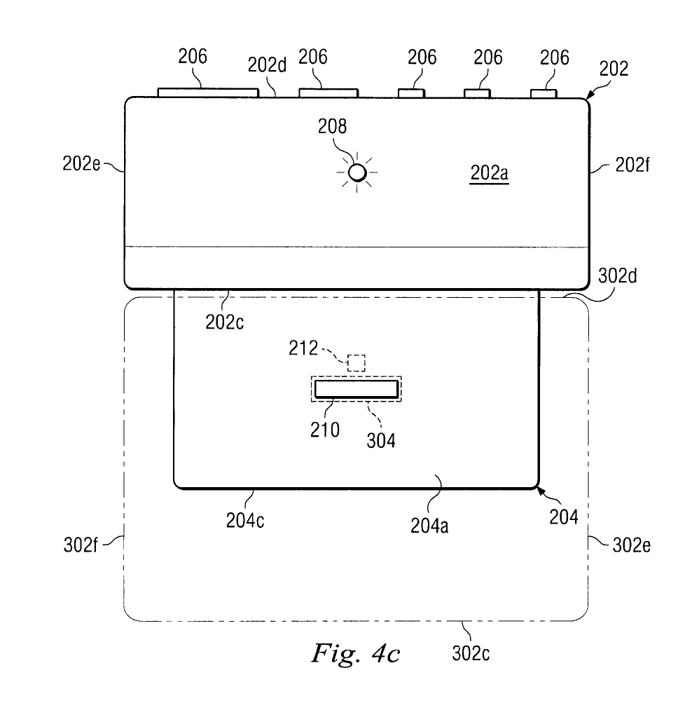

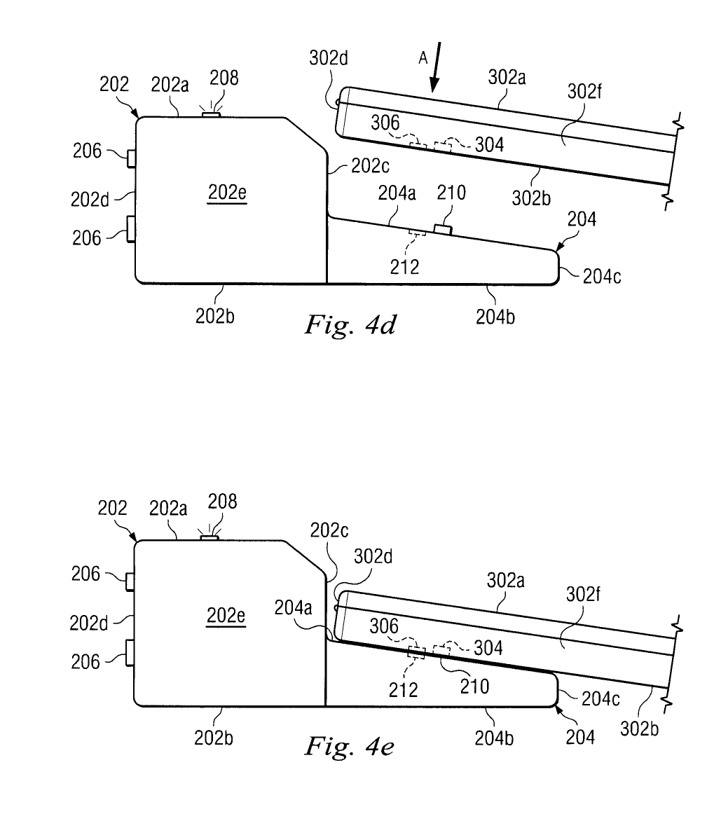

Referring now to FIGS. 2a, 2b, 3, 4a and 4b, a method 400 for aligning connectors is illustrated. The method 400 begins at step 402 where the docking device 200 of FIGS. 2a and 2b with the first connector 210 is provided. The method 400 then proceeds to step 404 where the IHS 300 of FIG. 3 with the second connector 304 is positioned above the docking device 200, as illustrate in FIG. 4b. With the IHS 300 positioned above the docking device 200 as illustrated in FIG. 4b, the second connector 304 on the IHS 300 is not proximate the first connector 210 on the docking device 200, and the second proximity sensor element 306 on the IHS 300 is not proximate the first proximity sensor element 212 on the docking device 200.

Referring now to FIGS. 2a, 2b, 3, 4a, 4c and 4d, the method 400 proceeds to step 406 where the IHS 300 is moved relative to the docking device 200. The IHS 300 is moved from the position illustrated in FIG. 4b until the second connector 304 on the IHS 300 is proximate the first connector 210 on the docking device 200, as illustrated in FIG. 4c, and the second proximity sensor element 306 on the IHS 300 is proximate the first proximity sensor element 212 on the docking device 200, as illustrated in FIG. 4d. When the second proximity sensor element 306 is proximate the first proximity sensor element 212, a signal is send to the indicator 208 that results in the indicator 208 providing an indication that the second connector 304 is proximate the first connector 210. In an embodiment, the indication may be a visual indication such as light, an audio indication such as sound, a combination of a visual and audio indication, and/or a variety of other indications known in the art. In an embodiment, the visual indication may include a blinking light that blinks faster or a light that gets brighter as the first proximity sensor element 212 gets closer to the 2^{nd} proximity sensor element 306. In an embodiment, the audio indication may include an audio signal that becomes more frequent or louder as the first proximity sensor element 212 gets closer to the second proximity sensor element 306. Once the indicator 208 provides the indication, as illustrated in FIG. 4c, and 4d, the method 400 proceeds to step 408 where the movement of the IHS 300 relative to the docking device 200 is stopped.

Referring now to FIGS. 2a, 2b, 3, 4a, 4d and 4e, the method 400 proceeds to step 410 where the second connector 304 on the IHS 300 is mated with the first connector 210 on the docking device 200. The IHS 300 is moved in a direction A such that the first connector 210 engages the second connector 304, as illustrated in FIG. 4e, to electrically couple the IHS 300 to the docking station 200. In an embodiment, the location of the first proximity sensor element 212 on the docking device 200 and the second proximity sensor element 306 on the IHS 300 may vary positions on the docking device 200 and the IHS 300, respectively, but ideally are aligned and positioned close to each other when the first connector 210 and the second connector 304 are aligned for mating. In an embodiment, the indicator 208 may be located on the IHS 300 and coupled to second proximity sensor element 306 rather than the first proximity sensor element 212 while providing the same functionality as described above.

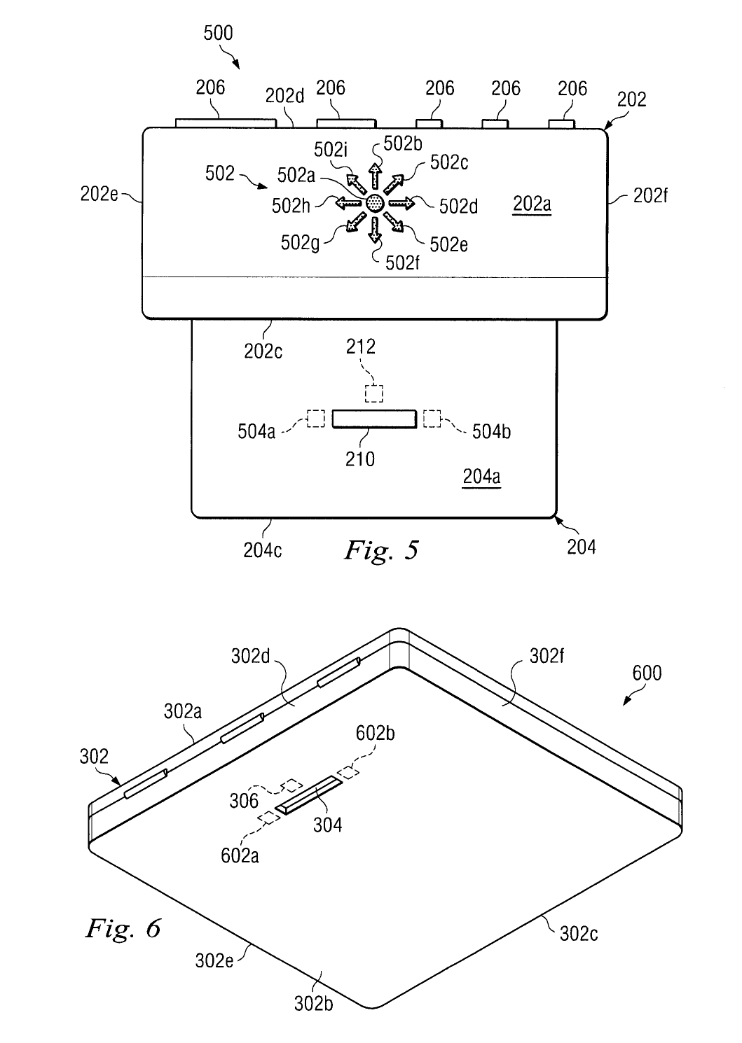

Referring now to FIG. 5, in an alternative embodiment, a docking device 500 is substantially similar in design and operation to the docking device 200, described above with reference to FIGS. 2a, 2b, 4a, 4b, 4c, 4d and 4e, with the provision of an indicator 502 replacing the indicator 208 and a plurality of additional first proximity sensor elements 504a and 504b. The indicator 502 includes a proximity indication component 502a and a plurality of directional indication components 502b, 502c, 502d, 502e, 502f, 502g, 502h and 5021 surrounding the proximity indication component 502a. The first proximity sensor elements 504a and 504b are located in a spaced apart orientation from each other and the first proximity sensor element 212.

Referring now to FIG. 6, in an alternative embodiment, an IHS 600 is substantially similar in design and operation to the IHS 300, described above with reference to FIGS. 3, 4a, 4b, 4c, 4d and 4e, with the provision of an a plurality of additional second proximity sensor elements 602a and 602b. The second proximity sensor elements 602a and 602b are located in a spaced apart orientation from each other and the second proximity sensor element 306.

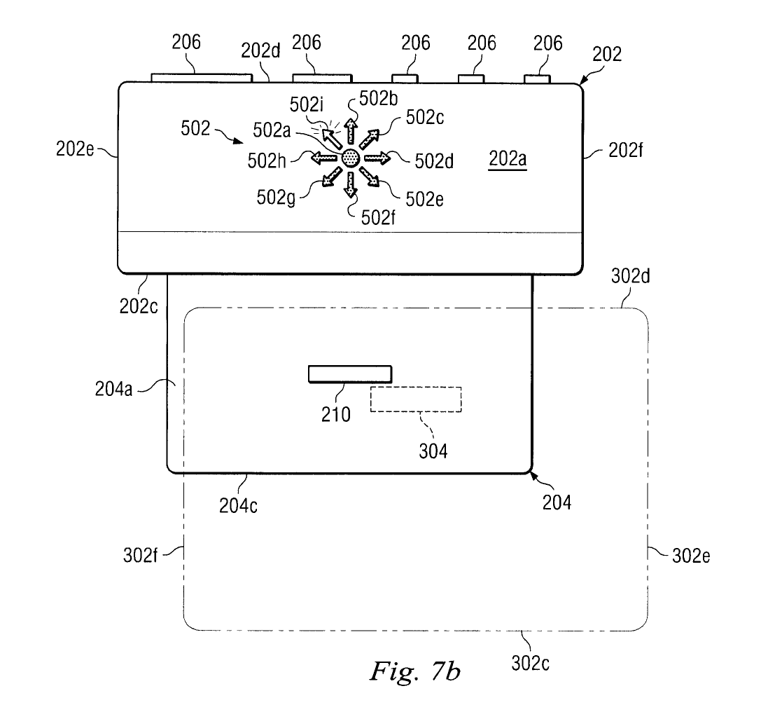

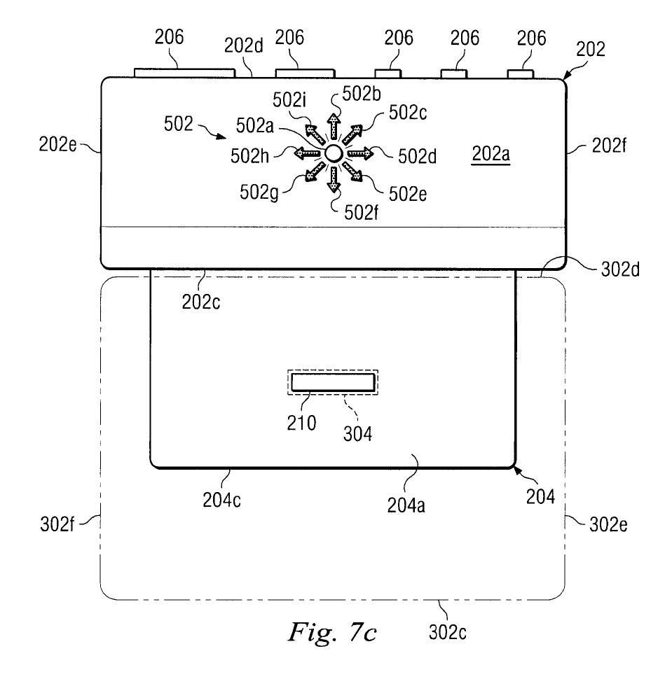

Referring now to FIGS. 5, 6, 7a and 7b, a method 700 for aligning connectors is illustrated. The method 700 begins at step 702 where the docking device 500 of FIG. 5 with the first connector 210 is provided. The method 700 then proceeds to step 704 where the IHS 600 of FIG. 6 with the second connector 304 is positioned above the docking device 500, as illustrated in FIG. 7b. With the IHS 600 positioned above the docking device 500 as illustrated in FIG. 7b, the second connector 304 on the IHS 600 is not proximate the first connector 210 on the docking device 500, and the second proximity sensor elements 306, 602a and 602b on the IHS 600 are not proximate the first proximity sensor elements 212, 504a and 504b on the docking device 500.

Referring now to FIGS. 5, 6, 7a, 7b and 7c, the method 700 proceeds to step 706 where the IHS 600 is moved relative to the docking device 500 upon indication of a direction to move the IHS 600 in order to align the second connector 304 on the IHS 600 with the first connector 210 on the docking device 500. The misalignment of the first proximity sensor elements 212, 504a and 504b and the second proximity sensor elements 306, 602a and 602b can be translated into a direction that the second connector 304 is offset from the first connector 210 using methods known in the art. A signal is then sent to the directional indication component 5021 of the indicator 502 that results in the directional indication component 5021 providing an indication of the direction to move the IHS 600 in order to align the second connector 304 with the first connector 210. In an embodiment, other indication components may be included in the indicator 502 such as, for example, rotational indication components that indicate that the IHS 600 should be rotated relative to the docking device 500. The IHS 600 is moved from the position illustrated in FIG. 7b until the second connector 304 on the IHS 600 is proximate the first connector 210 on the docking device 500, as illustrated in FIG. 7c, and the second proximity sensor elements 306, 602a and 602b on the IHS 600 are proximate the first proximity sensor elements 212, 504a and 504b on the docking device 500. With the second proximity sensor elements 306, 602a and 602b proximate the first proximity sensor elements 212, 504a and 504b, the signal to the directional indication component 5021 ceases, and a signal is send to the proximity indication component 502a of the indicator 502 that results in the proximity indication component 502a providing an indication that the second connector 304 is proximate the first connector 210. In an embodiment, the indication may be a visual indication such as light, an audio indication such as sound, a combination of a visual and audio indication, and/or a variety of other indications known in the art. Once the proximity indication component 502a provides the indication, as illustrated in FIG. 7c, the method 700 proceeds to step 708 where the movement of the IHS 600 relative to the docking device 500 is stopped.

Referring now to FIGS. 5, 6, 7a and 4e, the method 700 proceeds to step 710 where the second connector 304 on the IHS 600 is mated with the first connector 210 on the docking device 500. The IHS 600 is moved towards the docking device 500 such that the first connector 210 engages the second connector 304, as illustrated in FIG. 4e, to electrically couple the IHS 600 to the docking station 500. In an embodiment, the location of the first proximity sensor elements 212, 504a and 504b on the docking device 200 and the second proximity sensor elements 306, 602a and 602b on the IHS 300 may vary positions on the docking device 500 and the IHS 600, respectively, but ideally are aligned and positioned close to each other when the first connector 210 and the second connector 304 are aligned for mating. In an embodiment, the indicator 502 may be located on the IHS 600 and coupled to second proximity sensor elements 306, 602a and 602b rather than the first proximity sensor elements 212, 504a and 504b while providing the same functionality as described above. In a embodiment, the indicator 502 including the directional indication components 502b, 502c, 502d, 502e, 502f, 502g, 502h and 5021 may provide the same functionality as described above with the omission of the first proximity sensor elements 504a and 504b and using only the single first proximity sensor element 212 such as, for example, when the first proximity sensor element 212 is an optical sensor.

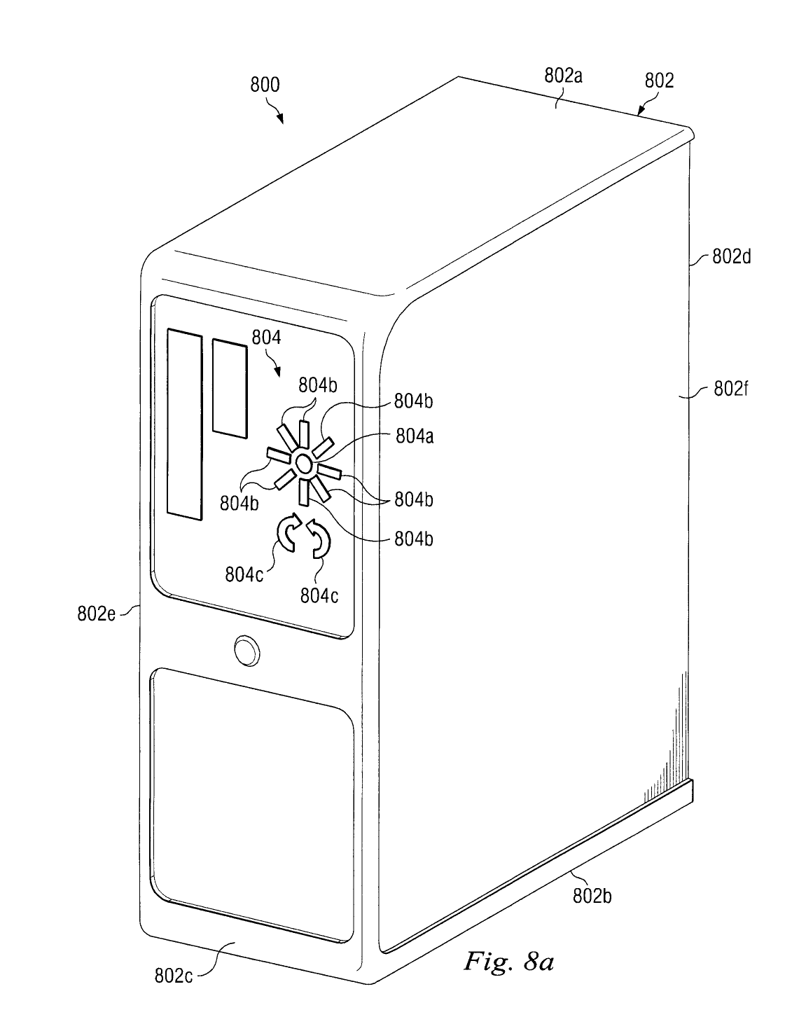

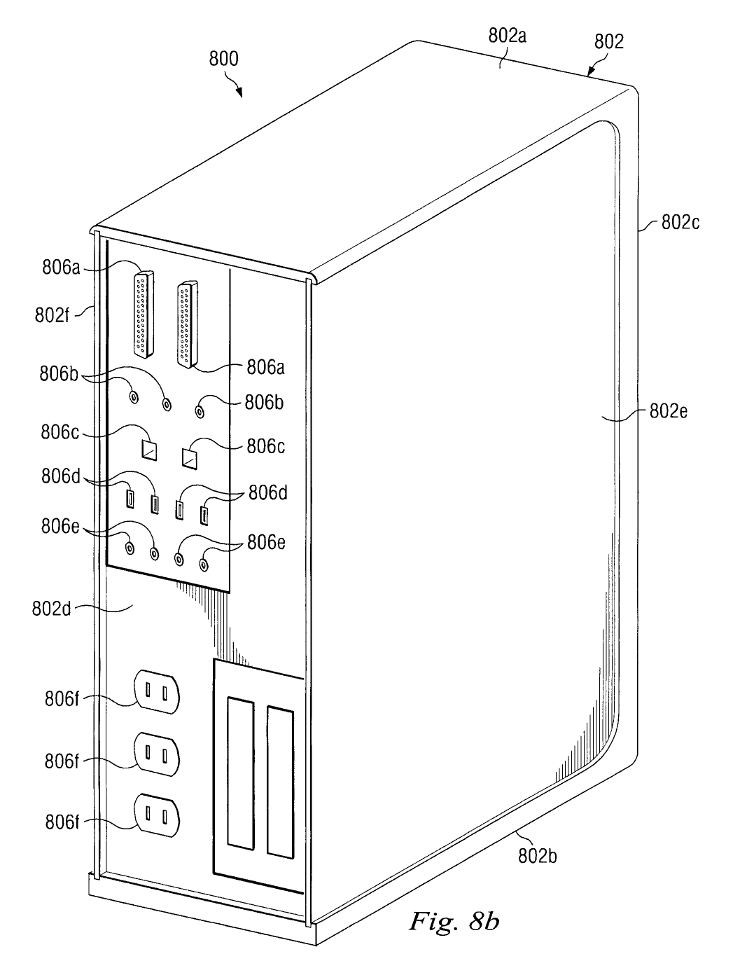

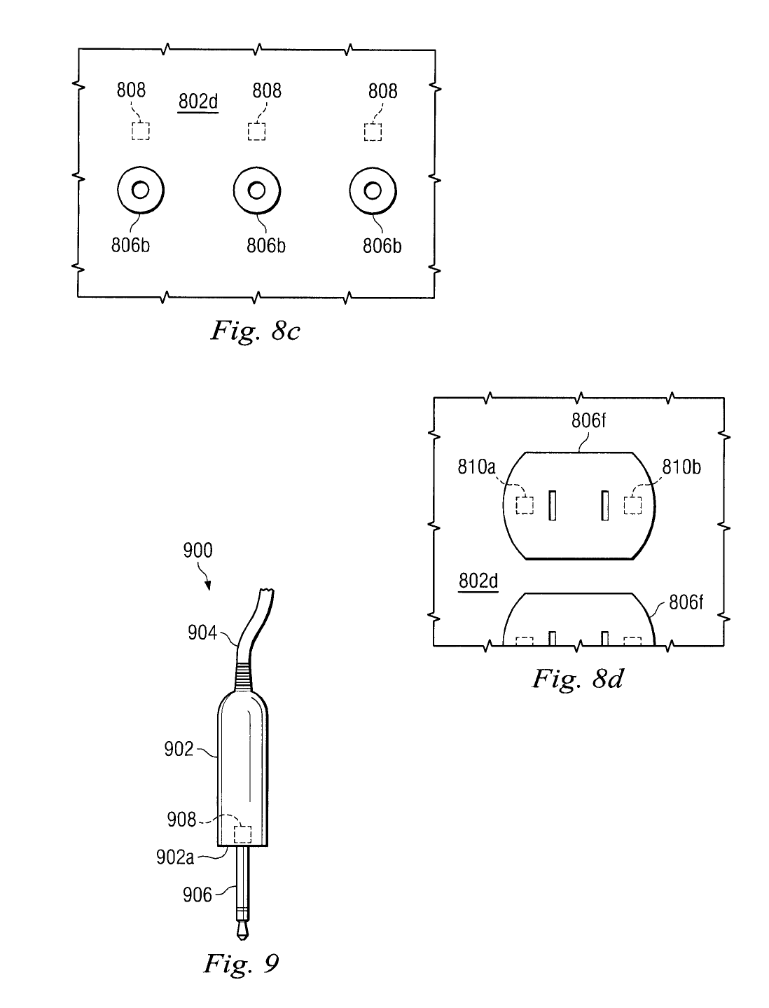

Referring now to FIGS. 8a, 8b, 8c and 8d, an IHS 800 is illustrated. The IHS includes a chassis 802 having a top surface 802a, a bottom surface 802b located opposite the top surface 802a, a front surface 802c extending between the top surface 802a and the bottom surface 802b, a rear surface 802d located opposite the front surface 802c and extending between the top surface 802a and the bottom surface 802b, a side surface 802e extending between the top surface 802a, the bottom surface 802b, the front surface 802c, and the rear surface 802d, and a side surface 802f located opposite the side surface 802e and extending between the top surface 802a, the bottom surface 802b, the front surface 802c, and the rear surface 802d. In an embodiment, the IHS 800 may be the IHS 100, described above with reference to FIG. 1, and the chassis 802 may be the chassis 116, described above with reference to FIG. 1. An indicator 804 is substantially similar in design and operation to the indicator 502, described above with reference to FIGS. 5, 7b and 7c, is located on the front surface 802c of the chassis 802 and includes a proximity indication component 804a and a plurality of directional indication components 804b, and includes the addition of a plurality of rotational indication components 804c. While the indicator 804 has been illustrated as located on the chassis 802, the indicator 804 may be located in a variety of other locations such as, for example, on a display (e.g. the display 110, described above with reference to FIG. 1) that is coupled to the chassis 802. A plurality of first connectors 806a, 806b, 806c, 806d, 806e and 806f are located on the rear surface 802d of the chassis 802. In an embodiment, the first connectors 806b each include a first proximity sensor element 808 located in the chassis 802 adjacent the rear surface 802d and each first connector 806b. As illustrated, the first proximity sensor elements 808 are housed within the chassis 802 and located adjacent the rear surface 802d of the chassis 802. However, the first proximity sensor elements 808 may be located on the rear surface 802d of the chassis 802 and/or in a variety of other locations on the chassis 802 as will be explained further below in reference to a second proximity sensor element that the first proximity sensor elements 808 are located to sense. In an embodiment, the first connectors 806f each include a plurality of first proximity sensor elements 810a and 810b located in each first connector 806f. As illustrated, the first proximity sensor elements 810a and 810b are housed within the first connectors 806f. However, the first proximity sensor elements 810a and 810b may be located on the surface of the first connectors 806f, on the rear surface 802d of the chassis 802, housed in the chassis 802 adjacent the rear surface 802d, and/or in a variety of other locations on the chassis 802 as will be explained further below in reference to a second proximity sensor element that the first proximity sensor elements 810a and 810b are located to sense. The first connectors 806a, 806c, 806d and 806e may also include first proximity sensor elements similar in design and operation to the first proximity sensor elements 808, 810a and 810b.

Referring now to FIG. 9, a second connector 900 is illustrated. The second connector 900 includes a base 902 having a front surface 902a and a cord 904 extending from the base 902 opposite the front surface 902a. A connector member 906 extends from the front surface 902a of the base 902. In an embodiment, the connector member 906 may include a Universal Serial Bus (USB) connector member, an audio connector member, a network connector member (e.g. a CAT5 connector member), and/or a variety of other connector members known in the art. A second proximity sensor element 908 is located in the base 902a adjacent the front surface 902a and the connector member 906.

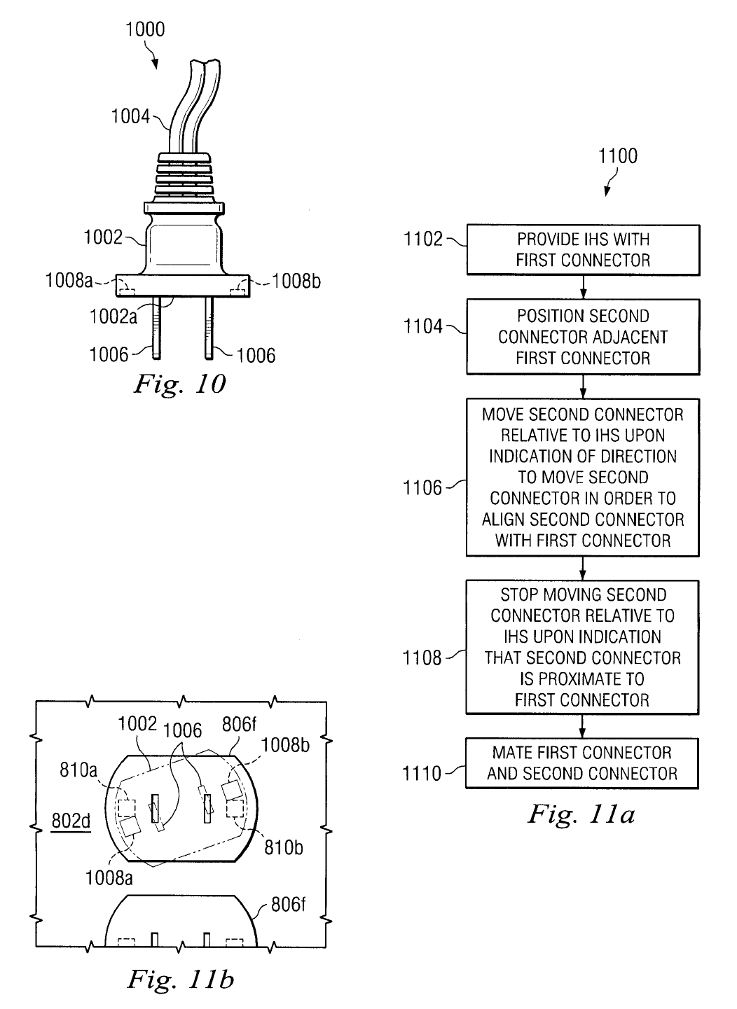

Referring now to FIG. 10 a second connector 1000 is illustrated. The second connector 1000 includes a base 1002 having a front surface 1002a and a cord 1004 extending from the base 1002 opposite the front surface 1002a. A plurality of connector members 1006 extend from the front surface 1002a of the base 1002. In an embodiment, the connector member 1006 may include a USB connector member, an AC adapter connector member, a power connector member, and/or a variety of other connector members known in the art. A plurality of second proximity sensor elements 1008a and 1008b are located in the base 1002a adjacent the front surface 1002a and on opposite sides of the plurality of connector members 1006.

Referring now to FIGS. 8a, 8b, 8c, 8d, 9, 10 and 11a a method 1100 for aligning connectors is illustrated. The method 1100 begins at step 1102 where the IHS 800 of FIGS. 8a, 8b, 8c, 8d with the first connectors 806a, 806b, 806c, 806d, 806e and 806f is provided. The method 1100 then proceeds to step 1104 where the second connectors 900 and 1000 are positioned adjacent the IHS 800. Often, a user may not have visual access of the rear surface 802d of the IHS 800, and when the second connectors 900 and 1000 are positioned adjacent the IHS 800 it may be difficult to find the first connectors 806b and 806f, respectively, that they are to be mated with. However, by positioning the second connectors 900 and 1000 adjacent IHS 800 and moving them adjacent the rear surface 802d, the first proximity sensor element 808 will sense the second proximity sensor element 908 and the first proximity sensor elements 810a and 810b will sense the second proximity sensor elements 1008a and 1008b. In an embodiment, the first proximity sensor element 808 will sense only the second proximity sensor element 908 and the first proximity sensor elements 810a and 810b will sense only the second proximity sensor elements 1008a and 1008b such that each proximity sensor element associated with a first connector senses only the second proximity sensor element that is associated with a second connector that is to be mated with that first connector.

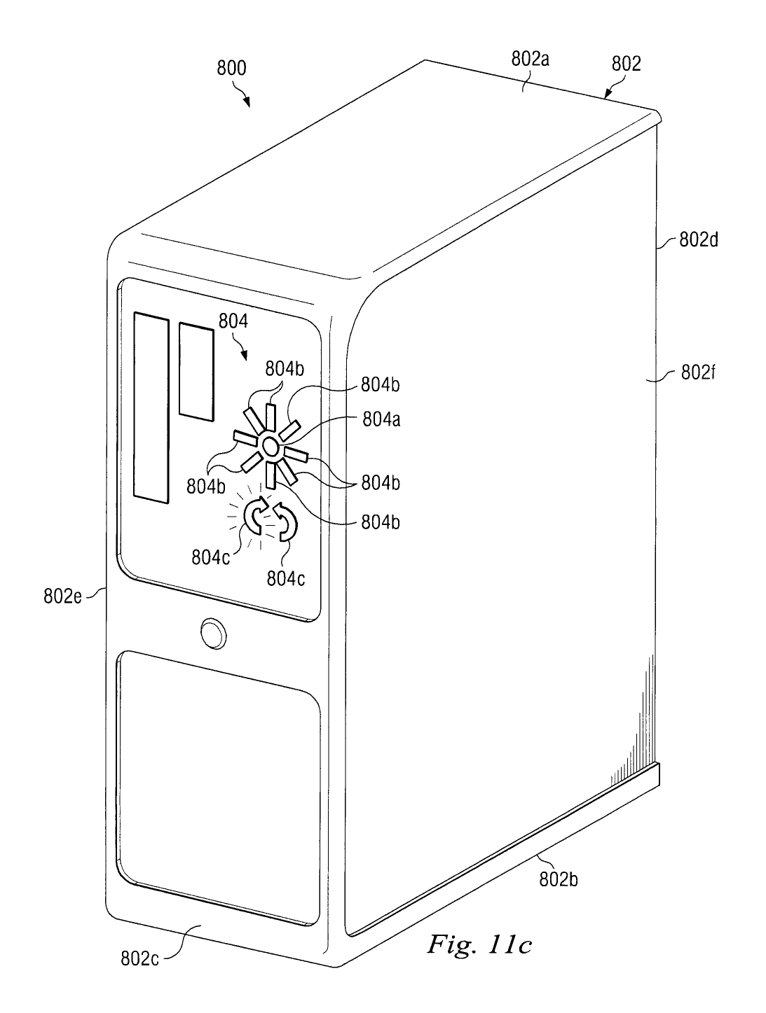

Referring now to FIGS. 8a, 8b, 8c, 8d, 9, 10, 11a, 11b and 11c, the method 1100 proceeds to step 1106 where the second connectors 900 and 1000 are moved relative to the IHS 800 upon indication of a direction to move the second connectors 900 and 1000 in order to align the second connectors 900 and 1000 with the first connectors 806b and 806f, respectively, on the IHS 800. For example, with the second connector 900, movement of the second connector 900 proximate the first connector 806b will result in the first proximity sensor element 808 sensing the second proximity sensor element 908 and sending a signal to the proximity indication component 804a of the indicator 802 to provide an indication. In an embodiment, the indication may be a visual indication such as light, an audio indication such as sound, a combination of a visual and audio indication, and/or a variety of other indications known in the art. In an embodiment, the visual indication may include a blinking light that blinks faster or a light that gets brighter as the first proximity sensor element 808 gets closer to the second proximity sensor element 908. In an embodiment, the audio indication may include an audio signal that becomes more frequent or louder as the first proximity sensor element 808 gets closer to the second proximity sensor element 908. In another example, with the second connector 1000, misalignment of the first proximity sensor elements 810a and 810b and the second proximity sensor elements 1008a and 1008b, illustrated in FIG. 11b can be translated into a direction or rotation that the second connector 1000 is offset from the first connector 806f using methods known in the art. In the illustrated embodiment, a signal is then sent to one of the rotational indication component 802c of the indicator 802 that results in the rotational indication component 802c providing an indication of the direction to rotate the second connector 1000 in order to align the second connector 1000 with the first connector 806f, illustrated in FIG. 11c. The second connector 1000 is moved from the position illustrated in FIG. 11b until the connector members 1006 on the second connector 1000 are aligned with the first connector 806f on the IHS 800 and the second proximity sensor elements 1008a and 1008b on the second connector 1000 are proximate the first proximity sensor elements 810a and 810b on the IHS 800. With the second proximity sensor elements 1008a and 1008b proximate the first proximity sensor elements 810a and 810b, a signal is send to the proximity indication component 804a of the indicator 802 that results in the proximity indication component 802a providing an indication that the second connector 1000 is proximate and aligned with the first connector 806f. Once the proximity indication component 804a provides the indication, the method 1100 proceeds to step 1108 where the movement of the second connectors 900 and 1000 relative to the IHS 800 is stopped.

The method 1100 proceeds to step 1110 where the second connectors 900 and 1000 on the IHS 800 are mated with the first connectors 806b and 806f, respectively, on the IHS 800. The second connectors 900 and 1000 are moved towards the IHS 800 such that the second connectors 900 and 1000 engages the first connectors 806b and 806f, respectively, to electrically couple the second connectors 900 and 1000 to the IHS 800. In an embodiment, the location of the first proximity sensor elements 808, 810a and 810b on IHS 800 and the second proximity sensor elements 908, 1008a and 1008b on the second connectors 900 and 100 may vary positions on the IHS 800 and the first connector 900 and second connector 1000 but ideally are aligned and positioned close to each other when the second connector 900 is aligned for mating with the first connector 806b and the second connector 1000 is aligned for mating with the first connector 806f.

Thus, systems and methods have been provided that assist a user in aligning and mating a pair of connectors. The systems and methods improve usability of equipment and reduce the likelihood of damage of equipment, in turn raising a users perception of the equipment. While the system has been illustrated for a docking station/IHS combination and for a plug/outlet combination, these illustrations have just been examples and it is envisioned that the system is applicable to any connector combination, particularly in situations where visual access to the connection site is obscured such as, for example, blind mating situations involving components (disk drives, memory sticks, etc) connecting to an IHS.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A connector alignment apparatus, comprising:
a first connector;
a first proximity sensor element operable to sense when a second connector is positioned proximate to the first connector; and
an indicator coupled to the first proximity sensor element and operable to provide an indication in response to the second connector being positioned proximate to the first connector.

2. The apparatus of claim 1, wherein the indicator comprises a light that is operable to provide a visual indication in response to the second connector being positioned proximate to the first connector.

3. The apparatus of claim 1, wherein the indicator comprises a speaker that is operable to provide an audio indication in response to the second connector being positioned proximate to the first connector.

4. The apparatus of claim 1, wherein the first proximity sensor element comprises a plurality of spaced-apart first proximity sensor elements that are each operable to sense a respective second proximity sensor element coupled to the second connector.

5. The apparatus of claim 1, wherein the indicator comprises a plurality of directional indication components that are operable to indicate which of a plurality of directions that the second connector should be moved in such that the second connector is aligned with the first connector.

6. The apparatus of claim 1, wherein the first proximity sensor element comprises a Hall-effect sensor, and wherein the second connector comprises a magnet that is detectable by the Hall-effect sensor in response to the second connector being position proximate the first connector.

7. The apparatus of claim 1, wherein the first proximity sensor element comprises an optical sensor, and wherein the second connector comprises an element that is detectable by the optical sensor in response to the second connector being position proximate the first connector.

8. An information handling system, comprising:
a chassis comprising a first proximity sensor element;
a processor mounted to the chassis,
a storage coupled to the processor;
a first connector located on the chassis;
a second connector operable to connect to the first connector;
a second proximity sensor element coupled to the second connector; and
an indicator operable to provide an indication that the second connector is proximate the first connector in response to the second proximity sensor element being positioned proximate to the first proximity sensor element.

9. The system of claim 8, wherein the indicator comprises a light that is operable to provide a visual indication in response to the second connector being positioned proximate to the first connector.

10. The system of claim 8, wherein the indicator comprises a speaker that is operable to provide an audio indication in response to the second connector being positioned proximate to the first connector.

11. The system of claim 8, wherein the first proximity sensor element comprises a plurality of spaced-apart first proximity sensor elements that are each operable to sense a respective second proximity sensor element coupled to the second connector.

12. The system of claim 8, wherein the indicator comprises a plurality of directional indication components that are operable to indicate which of a plurality of directions that the second connector should be moved in such that the second connector is aligned with the first connector.

13. The system of claim 8, wherein the first proximity sensor element and the second proximity sensor element comprise a combination of a Hall-effect sensor and a magnet that may be sensed by the Hall-effect sensor in order to determine whether the second connector is positioned proximate the first connector.

14. The system of claim 8, wherein the first proximity sensor element and the second proximity sensor element comprise a combination of a optical sensor and an element that may be sensed by the optical sensor in order to determine whether the second connector is positioned proximate the first connector.

15. The system of claim 8, wherein the second connector is located on an information handling system docking device.

16. The system of claim 8, wherein the second connector comprises a plug located on a distal end of a cord.

17. A method for aligning connectors, comprising:
providing a first connector;
sensing that a second connector is proximate to the first connector; and
indicating that the second connector is proximate to the first connector.

18. The method of claim 17, wherein the indicating comprises providing an indication chosen from the croup consisting of a visual indication, an audio indication, and combination thereof.

19. The method of claim 17, further comprising:
sensing that the second connector is misaligned with the first connector; and
indicating a direction to move the second connector in order to align the second connector with the first connector.

20. The method of claim 17, further comprising:
mating the second connector with the first connector.
